(19) United States
(12) Patent Application Publication
(10) Pub. No.: US 2025/0217622 A1
(43) Pub. Date: Jul. 3, 2025

(54) UNDERWATER ACOUSTIC TARGET RECOGNITION (UATR) METHOD BASED ON RECURRENT NEURAL NETWORK (RNN) STRUCTURE AND DIFFERENTIAL LEARNING RATE (LR) RETRAINING

(71) Applicant: Hangzhou Dianzi University, Hangzhou City (CN)

(72) Inventors: Wanzeng KONG, Hangzhou City (CN); Zhiquan BAI, Hangzhou City (CN); Yidi ZHU, Hangzhou City (CN); Xin’ao LI, Hangzhou City (CN)

(21) Appl. No.: 18/921,574

(22) Filed: Oct. 21, 2024

(30) Foreign Application Priority Data
Dec. 29, 2023 (CN) 202311854172.0

(51) Int. Cl. G06N 3/0442; G06N 3/084

(52) U.S. Cl. CPC G06N 3/0442; G06N 3/084

(57) ABSTRACT

Provided is an underwater acoustic target recognition (UATR) method based on a recurrent neural network (RNN) structure and differential learning rate (LR) retraining, which is specifically aimed at identification and classification issues of ship underwater acoustic targets. Specific implementation steps include: 1. A ship underwater acoustic signal is preprocessed. 2. A UATR depth model is constructed based on a pre-trained model. 3. Retraining configuration. 4. The model is retrained to implement migration to a target domain. 5. A high-performance classification model for UATR is trained. In a model structure of this application, the pre-trained model is combined with the newly added RNN structure and a classification layer, so that a model obtained after retraining can more accurately identify an underwater acoustic target.

### CROSS REFERENCE TO RELATED APPLICATION

This patent application claims the benefit and priority of Chinese Patent Application No. 202311854172.0, filed with the China National Intellectual Property Administration on Dec. 29, 2023, the disclosure of which is incorporated by reference herein in its entirety as part of the present application.

### TECHNICAL FIELD

The present disclosure pertains to the technical fields of artificial intelligence (AI) and UATR, and specifically relates to a UATR method based on an RNN structure and differential LR retraining.

### BACKGROUND

As an important means of perception, an underwater acoustic technology plays a key role in many fields such as military, industry, and scientific research. Especially in the military field, underwater acoustic data is widely used in key tasks such as underwater target detection, navigation, and communication due to high efficiency and relatively low noise of the underwater acoustic data in underwater propagation, and plays an indispensable role in strategic command and operational execution. Therefore, it is of great significance to improve an application level of the underwater acoustic technology in the military field, especially accuracy and reliability of UATR.

UATR has long relied on a degree of familiarity of a professional sonar operator with noise signals. The sonar operator needs to classify vessels by sensitively determining tiny differences. Training a professional sonar operator requires huge costs and efforts. In addition, determining about noise signals not only requires experience, but also is limited by a physical condition and an environmental condition. A human ear has limited ability to perceive a frequency and an amplitude of a sound signal. This method faces great challenges as a marine device is continuously upgraded. A sonar detection device continues to develop and improve, and a noise signal sent by an offshore device becomes weaker and weaker. To obtain as much information as possible, the device continuously upgrades to reduce a possibility of sound sending. In this process of continuous upgrading and development, using machines to achieve UATR of ship noise has become a research focus in the military and civil fields.

Particularity of the underwater acoustic data also poses a series of challenges for processing and analysis of the underwater acoustic data, for example, problems such as signal distortion and data confidentiality. Complexity of a marine environment, including variation of a sound velocity profile, a multipath effect, and the like, makes an underwater acoustic signal vulnerable to attenuation and distortion during transmission, which increases difficulty of UATR. Due to widespread application of the underwater acoustic technology in the military field, acquisition of underwater acoustic data is often limited by target confidentiality, resulting in relatively limited datasets available for research and a lack of sufficient coverage of real military scenarios. All of this makes research on the UATR face many technical and data challenges.

In this field background, the UATR becomes a research direction of great concern. The UATR aims to identify and understand various targets in underwater and surface environments, including a submarine, a warship, and a civilian ship, by analyzing underwater acoustic data. Accuracy of the UATR is directly related to benefits of fields such as military and marine resource management. However, due to complexity and limitations of the underwater acoustic data, the UATR faces a series of challenges such as a low signal-to-noise ratio (SNR), insufficient datasets, and the like.

Resolving these problems by using a deep learning (DL) technology has become one of current research hotspots. Powerful capabilities of DL on feature extraction and pattern recognition make the DL ideal for processing complex data in the UATR. Representation learning (RL) plays a key role in the DL, which aims to automatically learn effective representations of data so that a representation can better reflect a structure and a feature of input data. As RL tools, a deep neural network (DNN) and a convolutional neural network (CNN) gradually extract and combine features of the input data by using multi-level nonlinear transformation to form a more informative representation. This automatically learned representation has hierarchical and abstract features, which help a DL model better understand and process complex data. Currently, pre-trained models are developing rapidly, for example, Chat Generative Pre-trained Transformer (ChatGPT), Bidirectional Encoder Representations from Transformers (BERT), and ImageNet-based models. A feedforward propagation process of a pre-trained model obtained by training large-scale datasets becomes an excellent representation manner. These pre-trained models perform well in tasks such as natural language processing (NLP) and image recognition (IR), providing richer and more complex information for the RL. By directly analyzing a feedforward propagation result of the pre-trained model or by analyzing the feedforward propagation result of the pre-trained model after a fine-tuning operation is performed on a downstream task, an important reference is provided for theoretical research and actual application of the RL, and excellent performance is displayed in some actual tasks.

In today's AI research, Transfer Learning (TL) has become a highly effective method, especially in a field in which data is limited or a task is particularly complex. A core idea of TL is to improve learning efficiency and performance on another related task by using knowledge learned from one task. This idea is very worth learning in the field of UATR, because high-quality marked data is often difficult to obtain, especially in military application involving sensitive or confidential information. With TL, existing large pre-trained models in other fields can be utilized to transfer knowledge of the existing large pre-trained models to underwater acoustic data, thereby weakening dependence on large amounts of marked underwater acoustic data. An underwater acoustic signal has a unique physical attribute and propagation characteristic of the underwater acoustic signal, which make direct application of the pre-trained models in the other fields unlikely to achieve an optimal effect. Therefore, selecting a proper source field and fine-tuning the pre-trained model with reference to a retraining policy, to adapt to particularity of the underwater acoustic signal, becomes a key to improving recognition accuracy and robustness. This method can improve performance of the model on a specific task, and can further enhances adaptability of the model to diversity and uncertainty in the underwater acoustic environment.

### SUMMARY

The present disclosure aims to provide a UATR method based on an RNN structure and differential LR retraining.

According to a first aspect, the present disclosure provides a UATR method based on an RNN structure and differential LR retraining, including the following steps:
step 1: preprocessing an underwater acoustic signal to establish a training set;
step 2: constructing a pre-trained model and a UATR depth model, where the UATR depth model includes a pre-training part, an RNN structure, and a classification layer; the pre-training part is obtained by removing a classification decision-making layer on the basis of the pre-trained model; the pre-trained model is pre-trained with a general audio dataset; and a network weight parameter in the pre-trained model is transferred to the pre-training part of the UATR depth model;
step 3: retraining the UATR depth model by using a training set; and setting different LRs for the pre-training part and each of the RNN structure and the classification layer, where an LR of the pre-training part in retraining is less than an LR of the RNN structure and the classification layer in retraining; and
step 4: identifying a target object in measured underwater acoustic data by using the UATR depth model obtained in step 3.

Preferably, the RNN structure includes a bidirectional long short-term memory (LSTM) layer and an attention mechanism layer; the bidirectional LSTM layer performs timing modeling on an input embedding vector; the attention mechanism layer weights an output of the bidirectional LSTM layer by using a fully connected (FC) layer, to obtain an attention weight; after the output of the bidirectional LSTM layer is weighted and summed according to the attention weight, a feature representation is obtained, and the feature representation is sent to the classification layer; and the classification layer outputs a prediction result.

Preferably, in step 3, the LR of the pre-training part in retraining is 0.0001 to 0.0005; and the LR of the RNN structure and the classification layer in retraining is 0.001 to 0.007.

Preferably, a size of a hidden layer of the bidirectional LSTM layer is 128.

Preferably, network weight parameters of the RNN structure, an attention mechanism, and the new classification layer are randomly initialized.

Preferably, the pre-trained model uses a classification model of a Visual Geometry Group (VGG)-like audio classification model (VGGish) or a classification model of Pretrained Audio Neural Networks (PANNs).

Preferably, a preprocessing process in step 1 includes slice processing and logarithmic Mel spectrum feature extraction; multiple consecutive samples obtained through preprocessing form one input sequence; and a specific process of extracting a logarithmic Mel spectrum feature is as follows: noise is removed and filtering is performed; a signal is divided into frames and windowed, and fast Fourier transform (FFT) is performed to obtain a power spectral density (PSD) of each frame; and the PSD of each frame is converted into a Mel frequency scale by using a Mel filter bank, and a logarithmic operation is performed on a spectral value to obtain a logarithmic Mel spectrum.

Preferably, a verification set is further established in step 1; and underwater acoustic data samples from a same batch are completely assigned to the training set or the verification set.

Preferably, the general audio dataset uses a dataset of an AudioSet.

Preferably, in step 3, samples in the training set are gradually input into the UATR depth model in a batch training manner, and forward propagation, loss calculation, back propagation (BP), and parameter update are performed.

According to a second aspect, the present disclosure provides a computer device, including a memory, a processor, and a computer program stored in the memory and capable of running on the processor, the memory stores the computer program, and the processor executes the foregoing UATR method based on an RNN structure and differential LR retraining.

According to a third aspect, the present disclosure provides a readable storage medium, storing a computer program, and the computer program, when executed by a processor, is used to implement the foregoing UATR method based on an RNN structure and differential LR retraining.

The present disclosure has the following beneficial effects:

1. In a model structure of the present disclosure, the pre-trained model (VGGish) is combined with the newly added RNN structure and the classification layer, so that a model obtained after retraining can more accurately identify an underwater acoustic target. The pre-trained model provides a strong basis for extracting general audio features, which can better adapt to specific underwater acoustic data after retraining, thereby effectively improving classification accuracy.

2. An inconsistent LR policy is implemented in training configuration of the present disclosure, which helps balance learning dynamics of the entire model, so that the model does not excessively disturb a stable pre-training feature while learning a new feature, thereby maintaining stability and efficiency of the entire model. Specifically, the pre-training part uses a relatively low LR to protect rich features that have been learned in the pre-trained model, to prevent valuable knowledge from being quickly “forgotten” in a retraining process. This helps maintain a general feature extraction capability of the pre-trained model, while allowing the model to gradually adapt to a new UATR task. For the newly added network structure part, a relatively high LR is set, to accelerate learning a specific feature of a UATR task by this part of structure, which helps the model to quickly capture key information in underwater acoustic data, and effectively form timing and attention patterns. This policy improves adaptability of the model to different data distribution and task requirements, and has an obvious effect on handling a complex and variable underwater acoustic signal.

3. The RNN structure in the present disclosure makes the model better at processing a timing signal. The RNN structure can effectively capture a long-term dependency in a time series, thereby better understanding and utilizing a timing characteristic of the underwater acoustic signal in an identification process. In addition, the attention mechanism introduced in the present disclosure enables the model to focus on processing key information in the signal. With this mechanism, the model can automatically identify and focus on a most important signal part for classification, thereby improving accuracy and robustness of identification.

4. Using the pre-trained model in the present disclosure partially reduces a requirement of training a model from scratch. This means that the model can accelerate a learning process of a new task, namely, the UATR task, by using general audio features that have been learned. In particular, in a case in which underwater acoustic data is limited by confidentiality and the like, this method can significantly improve training efficiency.

5. A retraining method in the present disclosure, in particular, a limitation on division of the training set and the verification set, helps the model to be better generalized to unseen data. This means that the model performs well in the training set, and maintains high-level performance in practical application.

### BRIEF DESCRIPTION OF THE DRAWINGS

FIG. 1 is an overall flowchart according to the present disclosure;

FIG. 2 is a flowchart of constructing a UATR depth model based on a pre-trained model according to the present disclosure;

FIG. 3 is a schematic structural diagram of a classification model of a VGGish used as a pre-trained model according to the present disclosure;

FIG. 4 is a schematic diagram of transferring a parameter of a pre-trained model to a UATR depth model according to the present disclosure;

FIG. 5 is a schematic diagram of training configuration for setting an LR in a retraining process according to the present disclosure; and

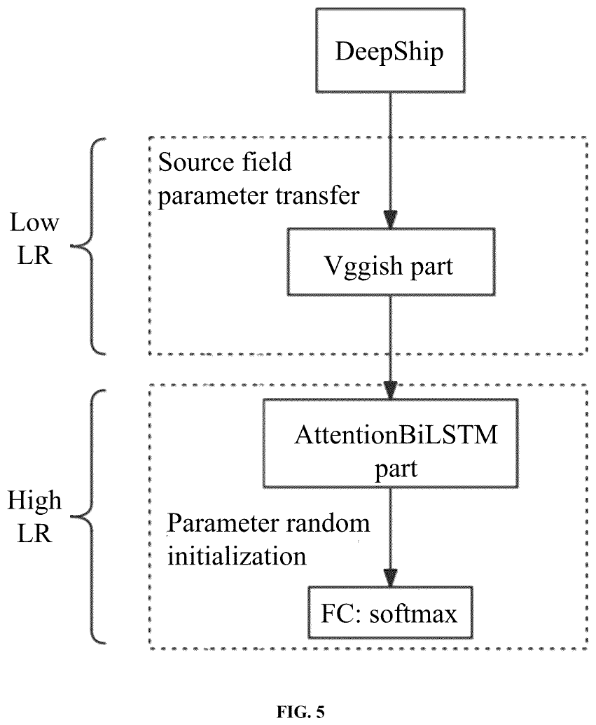

FIG. 6 is a schematic diagram of an RNN structure according to the present disclosure.

### DETAILED DESCRIPTION OF THE EMBODIMENTS

The following further describes the present disclosure with reference to the accompanying drawings.

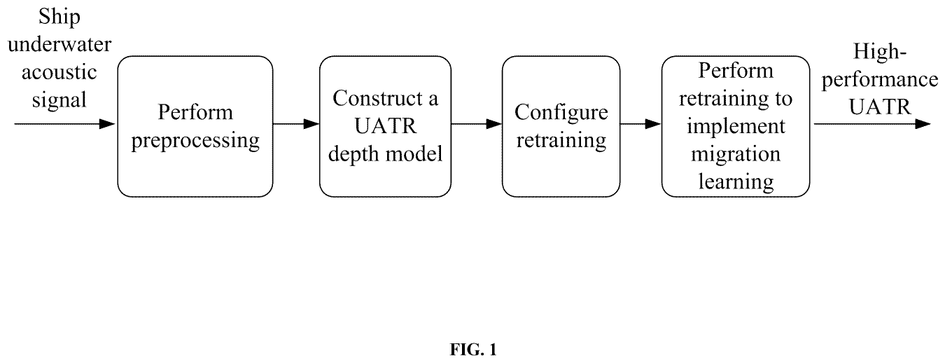

As shown in FIG. 1, a UATR method based on an RNN structure and differential LR retraining includes the following steps:

Step 1: Preprocess a ship underwater acoustic signal.

Slice processing is performed on labeled underwater acoustic data, and a sonar frequency file is sliced into multiple segments of samples with a duration of 1 second. Ten consecutive samples form one input sequence. Each input sequence forms a training set and a verification set. In this embodiment, a special measure is taken for dividing the training set and the verification set, to ensure effectiveness and a generalization capability of model training. The special measure is specifically as follows: Underwater acoustic data slices from a same batch are completely assigned to the training set or the verification set. Therefore, the training set and the verification set are prevented from containing different slices of data acquired in the same batch, thereby reducing a risk of data leakage and overfitting.

A logarithmic Mel spectrum feature is extracted for each sample. A specific process of extracting the logarithmic Mel spectrum feature is as follows: Noise is removed and filtering is performed; a signal is divided into frames and windowed, and FFT is performed to obtain a PSD of each frame; and the PSD of each frame is converted into a Mel frequency scale by using a Mel filter bank, and a logarithmic operation is performed on a spectral value to obtain a logarithmic Mel spectrum. This process converts a sonar signal sample into a feature vector, which provides a basis for a subsequent UATR task that is input into a DNN.

In this embodiment, the labeled underwater acoustic data uses a specific underwater acoustic dataset DeepShip.

Step 2: Construct a UATR depth model based on a pre-trained model.

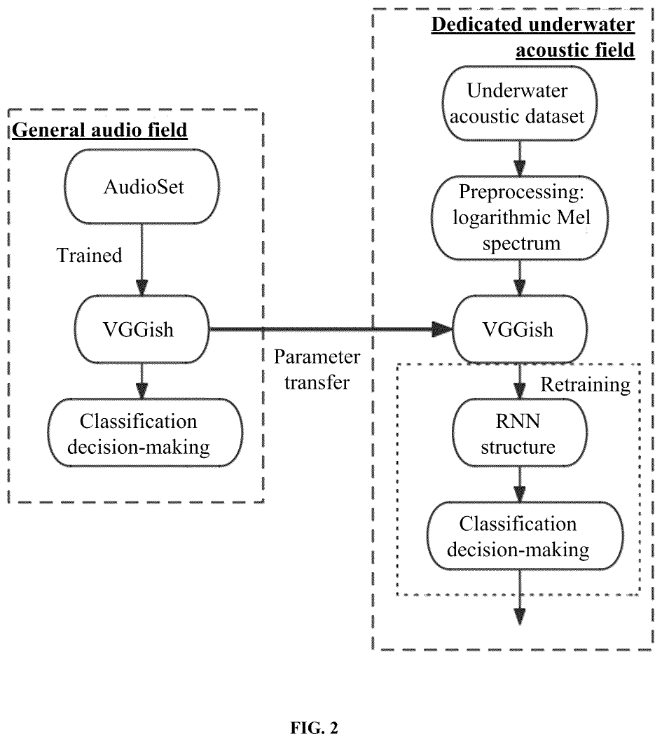

As shown in FIG. 2, a process of constructing the UATR depth model is as follows: A classification model of a VGGish obtained by training a large-scale dataset of an AudioSet in the general audio field is obtained as the pre-trained model. A network weight parameter in the pre-trained model is transferred to a dedicated underwater acoustic domain model, and is retrained to obtain the UATR depth model that can complete a classification decision-making task for UATR. In some other embodiments, the pre-trained model may alternatively use a classification model of PANNs.

In the above process, the dedicated underwater acoustic domain model inherits, adjusts, and retrains a structure and a weight of the pre-trained model, to focus on a characteristic of the underwater acoustic signal. The dedicated underwater acoustic domain model removes a classification decision-making part of the original model on the basis of the pre-trained model, and introduces a feature extraction layer and a new classification decision-making layer that are specifically used for the underwater acoustic signal.

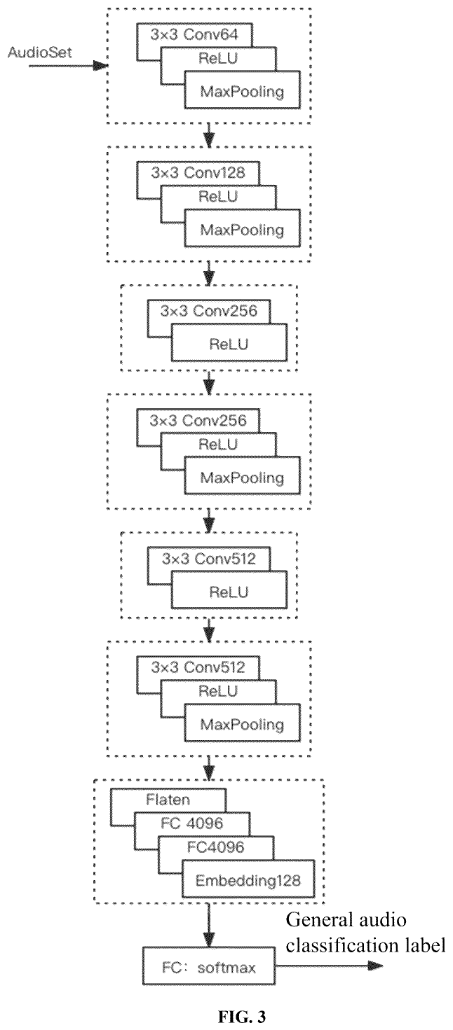

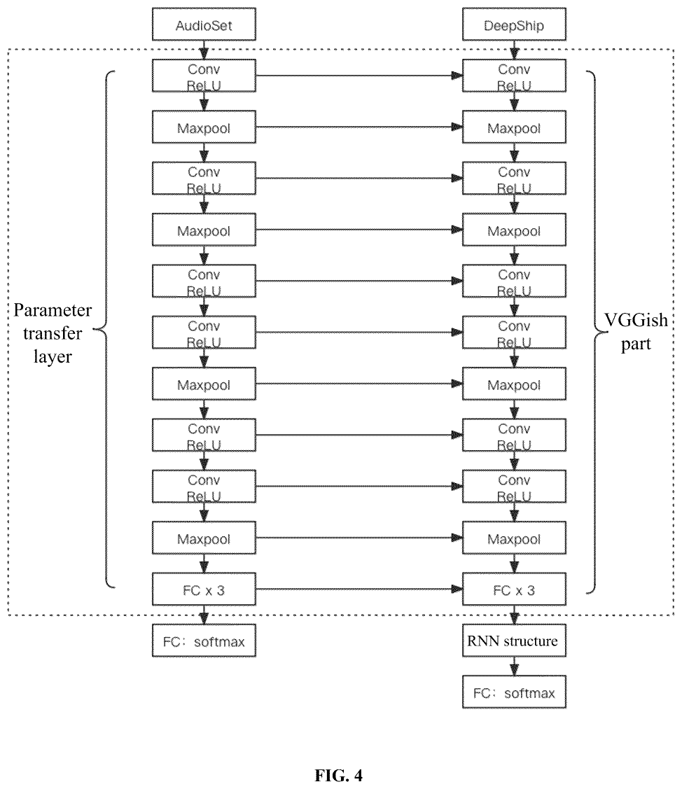

As shown in FIG. 3, in this embodiment, the classification model of the VGGish used as the pre-trained model is obtained by supervised training the dataset of the AudioSet, and labels of the AudioSet come from more than 600 audio events. A network structure of the classification model of the VGGish includes a series of convolutional layers and pooling layers. Specifically, the series of convolutional layers (each layer uses a Rectified Linear Unit (ReLU) activation function) are passed. In this embodiment, there are six convolutional layers, and quantities of convolutional cores of the six convolutional layers are 64, 128, 256, 256, 512, and 512 respectively. First, second, fourth, and sixth convolution layers are followed by one pooling layer (maxpooling). The extracted feature is mapped to a 128-dimensional embedding vector by using several FC layers. These network structures may be used to extract an advanced feature of an input signal by learning and updating a network weight parameter during BP. The pre-trained model part constructed in this step has a capability of extracting a general audio data (GAD) feature. As shown in FIG. 4, the UATR depth model constructed in this step uses only a feature extraction part of the pre-trained model, that is, the classification decision-making part in the pre-trained model is removed.

The UATR depth model includes a pre-training part, an RNN structure (preferably, a bidirectional LSTM combined with an attention mechanism layer), and a new classification layer. The pre-training part removes the classification decision-making layer on the basis of the pre-trained model. The RNN structure is better at processing sequence data, and helps improve accuracy of underwater acoustic signal recognition (UASR) by the UATR depth model. An output of the pre-training part is represented by an embedded layer of 128 dimensions. Network weight parameters of the RNN structure, an attention mechanism, and the new classification layer are randomly initialized. The classification layer uses an FC layer, and a dimension of the FC layer is determined by a quantity of label categories of a training dataset.

After passing through the pre-trained model, the UATR depth model inputs an embedding vector extracted from the pre-trained model into the RNN structure. In this embodiment, the RNN structure includes one bidirectional LSTM layer and one attention mechanism layer. First, sequence modeling is performed on the input embedding vector by using the bidirectional LSTM layer. Then, the attention mechanism layer is introduced. The attention mechanism layer weighs the output of the bidirectional LSTM layer by using one FC layer to obtain an attention weight, and normalization is performed by using a softmax function. Finally, the output of the bidirectional LSTM layer with the attention weight is weighted and summed, to obtain a final feature representation under the attention mechanism. A final output of the whole UATR depth model is to classify the feature representation under the attention mechanism by using the full connection layer, and a dimension of the output matches a quantity of target categories.

In this embodiment, a size of a hidden layer of the bidirectional LSTM layer is 128.

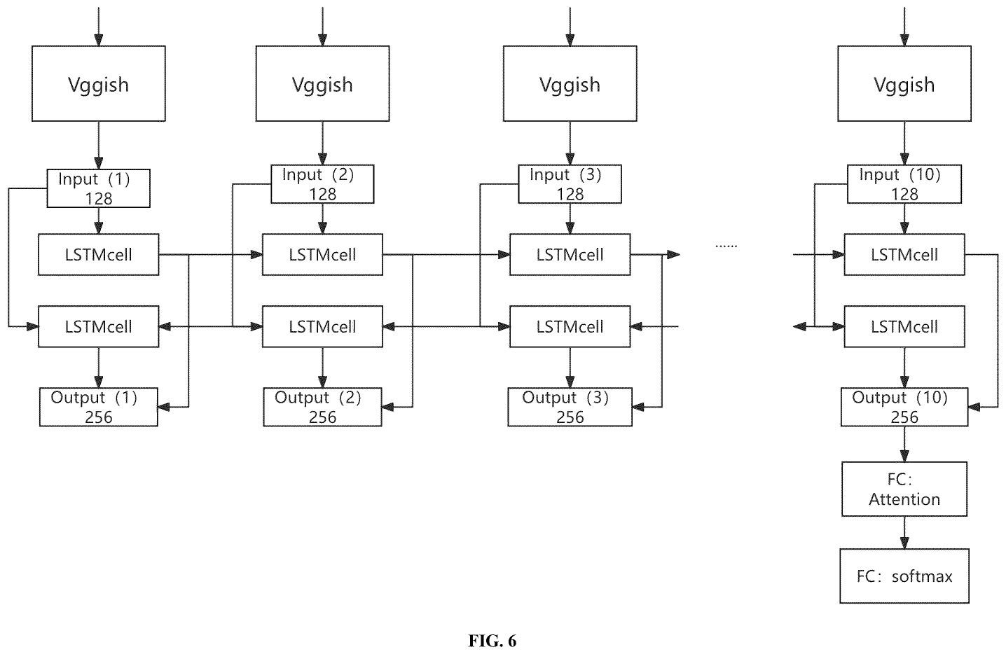

As shown in FIG. 6, from a perspective of processing a time sequence, a working process of the RNN structure in this embodiment is as follows: The model receives a sequence whose length is 10, and these sequences are input into the bidirectional LSTM layer at one time. The bidirectional LSTM layer includes LSTM units in two directions, and can capture contextual information of time steps in a sequence. A forward LSTM unit processes sequence information from the beginning to the end, while a reverse LSTM unit processes reverse sequence information from the end to the beginning. The LSTM in each direction has 128 hidden units, so that the model can maintain a time context of a sequence while extracting a feature at each time step. After the entire sequence is processed, the bidirectional LSTM layer outputs hidden status sequences in the two directions. In the RNN structure, the model takes an output of the bidirectional LSTM layer at a last time step and focuses on a final status of the sequence, which contains cumulative information of the entire sequence. The output at the last time step is passed to the attention mechanism layer. The attention mechanism layer obtains the attention weight. A weighted feature is sent to the classification layer for final classification decision-making.

Step 3: Retraining configuration.

In this embodiment, the retraining configuration focuses on adjusting an LR, optimizing a training policy, and ensuring proper partitioning of the dataset. To effectively use a feature that has been learned in the pre-trained model, in a retraining process, a relatively low LR is set for the pre-training part of the UATR depth model. It is found, through limited times of experiments, that an effect is relatively prominent and stable when the LR is set to be 0.0001 to 0.0005, thereby avoiding a drastic adjustment to a valuable pre-training parameter in a retraining phase, and stabilizing a model training process. Further, a relatively high LR is set for the newly added RNN structure and the classification layer for training. It is found, through limited times of experiments, that an effect is relatively prominent and stable when the LR is set to be 0.001 to 0.007, to quickly adapt to and better learn a characteristic of an underwater acoustic target. A combination of 0.0003 and 0.001 is the best.

Step 4: Retrain the model to implement migration to a target domain.

In a phase of implementing retraining, a weight parameter of the UATR depth model is initialized, a parameter from the VGGish is inherited for the pre-training part, and an initial value of the parameter is maintained and is fine-tuned with a low LR. The newly added RNN structure and the classification layer are randomly initialized and trained at a high LR. In a training process, in this embodiment, samples in the training set are gradually input in a batch training manner, and forward propagation, loss calculation, BP, and parameter update are performed.

In addition, to monitor a learning progress and performance of the model, in this embodiment, the model is periodically evaluated based on the verification set, key indicators such as an accuracy rate and a recall rate are monitored, and adjustment is performed as required. Through iterative optimization and adjustment, the model gradually learns how to extract a key feature from the underwater acoustic signal and perform effective target recognition.

After the retraining process ends, a final evaluation is performed on the model, to ensure good recognition performance of the model on various underwater acoustic targets. In this case, the model has been adapted to the UATR task, and may be applied to processing and analysis of an actual underwater acoustic signal.

Step 5: Train a high-performance classification model for UATR.

The UATR depth model obtained in step 4 is verified by using the verification set obtained based on the Deepship dataset. After verification, measured underwater acoustic data is preprocessed to extract a logarithmic Mel spectrum feature, and is input to the UATR depth model, and the UATR depth model outputs a target object type in the measured underwater acoustic data.

The Deepship dataset contains four types of underwater acoustic target samples: Cargo, Passengership, Tanker, and Tug. 75% of data samples in each category are randomly selected as the training set, and 25% of the data samples are used as the verification set. The LR of the pre-trained model part is 0.0003, and an LR of a parameter random initialization part is 0.001. A confusion matrix for the verification set at the 50th round of training is shown in Table 1, where a vertical axis is a prediction label, and a horizontal axis is a real result. Classification task performance calculation is shown in Table 2, where a vertical axis is each category, and a horizontal axis is each classification task performance parameter of the category.

TABLE 1

| | Cargo | Passengership | Tanker | Tug |
|---|---|---|---|---|
| Cargo | 922 | 10 | 15 | 3 |
| Passengership | 13 | 1113 | 7 | 8 |
| Tanker | 22 | 12 | 1047 | 7 |
| Tug | 7 | 4 | 0 | 997 |

TABLE 2

| | Precision | Recall | F1-score | Support |
|---|---|---|---|---|
| Cargo | 0.96 | 0.97 | 0.96 | 950 |
| Passengership | 0.98 | 0.98 | 0.98 | 1141 |
| Tanker | 0.98 | 0.96 | 0.97 | 1088 |
| Tug | 0.98 | 0.99 | 0.99 | 1008 |

For a differential LR policy in a retraining configuration phase of this method, some comparative experimental data is shown herein.

When the differential LR policy is not used and an LR of retraining is set to 0.001, a confusion matrix for the verification set at the 50th round is shown in Table 3, where a vertical axis is a prediction label, and a horizontal axis is a real result. Classification task performance calculation is shown in Table 4, where a vertical axis is each category, and a horizontal axis is each classification task performance parameter of the category.

TABLE 3

| | Cargo | Passengership | Tanker | Tug |
|---|---|---|---|---|
| Cargo | 0 | 950 | 0 | 0 |
| Passengership | 0 | 1141 | 0 | 0 |
| Tanker | 0 | 1088 | 0 | 0 |
| Tug | 0 | 1008 | 0 | 0 |

TABLE 4

| | Precision | Recall | F1-score | Support |
|---|---|---|---|---|
| Cargo | 0 | 0 | 0 | 950 |
| Passengership | 0.27 | 1 | 0.43 | 1141 |
| Tanker | 0 | 0 | 0 | 1088 |
| Tug | 0 | 0 | 0 | 1008 |

It can be learned from Table 3 and Table 4 that the model is obviously affected by not using the differential LR policy and taking the relatively high LR of 0.001. Consequently, in a BP process, a recognition effect of the model can no longer be better optimized, a valuable pre-training parameter part in the model is completely destroyed, it completely falls into a local optimum, and all vessels are determined as a maximum quantity of Passengership. This conclusion can also be verified by various average accuracy results of the model on the verification set in training rounds in the model training process.

TABLE 5

| Training | Various average |
|---|---|
| rounds | accuracy |
| 10 | 0.756 |
| 20 | 0.26 |
| 30 | 0.26 |
| 40 | 0.26 |
| 50 | 0.273 |

It is learned from Table 5 that, because the differential LR policy is not adopted and an LR is excessively high, a model classification effect is best at the 10th training round, and afterwards, it obviously falls into a local optimum, and performance and stability of the model are greatly degraded.

Experimental results obtained by using a training configuration method in which the differential LR policy is not used and the LR of retraining is set to be greater than 0.001 are all similar to those shown in Table 3, Table 4, and Table 5, or are even more unstable and inaccurate. Experimental results are not enumerated herein.

When the differential LR policy is not used and the LR of retraining is set to 0.0003, a confusion matrix for the verification set at the 50th round is shown in Table 6, where a vertical axis is a prediction label, and a horizontal axis is a real result. Classification task performance calculation is shown in Table 7, where a vertical axis is each category, and a horizontal axis is each classification task performance parameter of the category.

TABLE 6

| | Cargo | Passengership | Tanker | Tug |
|---|---|---|---|---|
| Cargo | 838 | 9 | 62 | 41 |
| Passengership | 25 | 1020 | 16 | 80 |
| Tanker | 82 | 24 | 937 | 45 |
| Tug | 11 | 6 | 0 | 991 |

TABLE 7

| | Precision | Recall | F1-score | Support |
|---|---|---|---|---|
| Cargo | 0.88 | 0.88 | 0.88 | 950 |
| Passengership | 0.96 | 0.89 | 0.93 | 1141 |
| Tanker | 0.92 | 0.86 | 0.89 | 1088 |
| Tug | 0.86 | 0.98 | 0.92 | 1008 |

By comparing Table 6 and Table 7 with Table 1 and Table 2, it can be learned that the retraining configuration is affected by not using the differential LR policy and taking a relatively low LR of 0.0003. Consequently, it is easier to fall into a local optimum in the training process, and classification performance in a same training round is significantly worse than classification performance obtained under the retraining configuration with the differential LR and the LR of 0.0003 for the pre-trained model part and the LR of 0.001 for the parameter random initialization part, and cannot better adapt to and learn the characteristic of the underwater acoustic target. Experimental results obtained by using a training configuration method in which the differential LR policy is not used and the LR of retraining is set to be less than 0.0003 are all similar to those shown in Table 6 and Table 7, and are all significantly worse than those shown in Table 1 and Table 2. Experimental results are not enumerated herein.

For this method, the RNN structure is added to the UATR depth model, and some comparative experimental data is shown herein.

The RNN structure is replaced with a common FC layer. A confusion matrix for the verification set at the 50th round is shown in Table 8, where a vertical axis is a prediction label, and a horizontal axis is a real result. Classification task performance calculation is shown in Table 9, where a vertical axis is each category, and a horizontal axis is each classification task performance parameter of the category.

TABLE 8

| | Cargo | Passengership | Tanker | Tug |
|---|---|---|---|---|
| Cargo | 871 | 12 | 51 | 16 |
| Passengership | 39 | 1040 | 35 | 27 |
| Tanker | 86 | 18 | 977 | 7 |
| Tug | 37 | 15 | 32 | 924 |

TABLE 9

| | Precision | Recall | F1-score | Support |
|---|---|---|---|---|
| Cargo | 0.84 | 0.92 | 0.88 | 950 |
| Passengership | 0.96 | 0.91 | 0.93 | 1141 |
| Tanker | 0.89 | 0.90 | 0.90 | 1088 |
| Tug | 0.95 | 0.92 | 0.93 | 1008 |

The RNN structure is replaced with a common convolutional layer. A confusion matrix for the verification set at the 50th round is shown in Table 10, where a vertical axis is a prediction label, and a horizontal axis is a real result. Classification task performance calculation is shown in Table 11, where a vertical axis is each category, and a horizontal axis is each classification task performance parameter of the category.

TABLE 10

| | Cargo | Passengership | Tanker | Tug |
|---|---|---|---|---|
| Cargo | 877 | 4 | 53 | 16 |
| Passengership | 27 | 1009 | 61 | 44 |
| Tanker | 56 | 18 | 1001 | 13 |
| Tug | 23 | 7 | 15 | 963 |

TABLE 11

| | Precision | Recall | F1-score | Support |
|---|---|---|---|---|
| Cargo | 0.89 | 0.92 | 0.91 | 950 |
| Passengership | 0.97 | 0.88 | 0.93 | 1141 |
| Tanker | 0.89 | 0.92 | 0.90 | 1088 |
| Tug | 0.93 | 0.96 | 0.94 | 1008 |

It is learned from the foregoing comparison experiment results that classification performance is significantly improved when the RNN structure is in the UATR depth model, and classification performance obviously degrades when the RNN structure is replaced with the common FC layer or the common convolutional layer.

What is claimed is:

1. An underwater acoustic target recognition (UATR) method based on a recurrent neural network (RNN) structure and differential learning rate (LR) retraining, comprising the following steps:
step 1: preprocessing an underwater acoustic signal to establish a training set;
step 2: constructing a pre-trained model and a UATR depth model, wherein the UATR depth model comprises a pre-training part, an RNN structure, and a classification layer; the pre-training part is obtained by removing a classification decision-making layer on the basis of the pre-trained model; the pre-trained model is pre-trained with a general audio dataset; and a network weight parameter in the pre-trained model is transferred to the pre-training part of the UATR depth model;
step 3: retraining the UATR depth model by using a training set; and setting different LRs for the pre-training part and each of the RNN structure and the classification layer, wherein an LR of the pre-training part in retraining is less than an LR of the RNN structure and the classification layer in retraining; and
step 4: identifying a target object in measured underwater acoustic data by using the UATR depth model obtained in step 3.

2. The UATR method based on an RNN structure and differential LR retraining according to claim 1, wherein the RNN structure comprises a bidirectional long short-term memory (LSTM) layer and an attention mechanism layer; the bidirectional LSTM layer performs timing modeling on an input embedding vector; the attention mechanism layer weights an output of the bidirectional LSTM layer by using a fully connected (FC) layer, to obtain an attention weight; after the output of the bidirectional LSTM layer is weighted and summed according to the attention weight, a feature representation is obtained, and the feature representation is sent to the classification layer; and the classification layer outputs a prediction result.

3. The UATR method based on an RNN structure and differential LR retraining according to claim 1, wherein in step 3, the LR of the pre-training part in retraining is 0.0001 to 0.0005; and the LR of the RNN structure and the classification layer in retraining is 0.001 to 0.007.

4. The UATR method based on an RNN structure and differential LR retraining according to claim 1, wherein a size of a hidden layer of the bidirectional LSTM layer is 128.

5. The UATR method based on an RNN structure and differential LR retraining according to claim 1, wherein the pre-trained model uses a classification model of a Visual Geometry Group (VGG)-like audio classification model (VGGish) or a classification model of Pretrained Audio Neural Networks (PANNs).

6. The UATR method based on an RNN structure and differential LR retraining according to claim 1, wherein a preprocessing process in step 1 comprises slice processing and logarithmic Mel spectrum feature extraction; multiple consecutive samples obtained through preprocessing form one input sequence; and a specific process of extracting a logarithmic Mel spectrum feature is as follows: noise is removed and filtering is performed; a signal is divided into frames and windowed, and fast Fourier transform (FFT) is performed to obtain a power spectral density (PSD) of each frame; and the PSD of each frame is converted into a Mel frequency scale by using a Mel filter bank, and a logarithmic operation is performed on a spectral value to obtain a logarithmic Mel spectrum.

7. The UATR method based on an RNN structure and differential LR retraining according to claim 1, wherein a verification set is further established in step 1; and underwater acoustic data samples from a same batch are completely assigned to the training set or the verification set.

8. The UATR method based on an RNN structure and differential LR retraining according to claim 1, wherein in step 3, samples in the training set are gradually input into the UATR depth model in a batch training manner, and forward propagation, loss calculation, back propagation (BP), and parameter update are performed.

9. A computer device, comprising a memory, a processor, and a computer program stored in the memory and capable of running on the processor, wherein the memory stores the computer program, and the processor executes the UATR method based on an RNN structure and differential LR retraining according to claim 1.

10. A non-transitory readable storage medium, storing a computer program, wherein the computer program, when executed by a processor, is used to implement the UATR method based on an RNN structure and differential LR retraining according to claim 1.

11. The computer device according to claim 9, wherein the RNN structure comprises a bidirectional long short-term memory (LSTM) layer and an attention mechanism layer; the bidirectional LSTM layer performs timing modeling on an input embedding vector; the attention mechanism layer weights an output of the bidirectional LSTM layer by using a fully connected (FC) layer, to obtain an attention weight; after the output of the bidirectional LSTM layer is weighted and summed according to the attention weight, a feature representation is obtained, and the feature representation is sent to the classification layer; and the classification layer outputs a prediction result.

12. The computer device according to claim 9, wherein in step 3, the LR of the pre-training part in retraining is 0.0001 to 0.0005; and the LR of the RNN structure and the classification layer in retraining is 0.001 to 0.007.

13. The computer device according to claim 9, wherein a size of a hidden layer of the bidirectional LSTM layer is 128.

14. The computer device according to claim 9, wherein the pre-trained model uses a classification model of a Visual Geometry Group (VGG)-like audio classification model (VGGish) or a classification model of Pretrained Audio Neural Networks (PANNs).

15. The computer device according to claim 9, wherein a preprocessing process in step 1 comprises slice processing and logarithmic Mel spectrum feature extraction; multiple consecutive samples obtained through preprocessing form one input sequence; and a specific process of extracting a logarithmic Mel spectrum feature is as follows: noise is removed and filtering is performed; a signal is divided into frames and windowed, and fast Fourier transform (FFT) is performed to obtain a power spectral density (PSD) of each frame; and the PSD of each frame is converted into a Mel frequency scale by using a Mel filter bank, and a logarithmic operation is performed on a spectral value to obtain a logarithmic Mel spectrum.

16. The computer device according to claim 9, wherein a verification set is further established in step 1; and underwater acoustic data samples from a same batch are completely assigned to the training set or the verification set.

17. The computer device according to claim 9, wherein in step 3, samples in the training set are gradually input into the UATR depth model in a batch training manner, and forward propagation, loss calculation, back propagation (BP), and parameter update are performed.

18. The non-transitory readable storage medium according to claim 10, wherein the RNN structure comprises a bidirectional long short-term memory (LSTM) layer and an attention mechanism layer; the bidirectional LSTM layer performs timing modeling on an input embedding vector; the attention mechanism layer weights an output of the bidirectional LSTM layer by using a fully connected (FC) layer, to obtain an attention weight; after the output of the bidirectional LSTM layer is weighted and summed according to the attention weight, a feature representation is obtained, and the feature representation is sent to the classification layer; and the classification layer outputs a prediction result.

19. The non-transitory readable storage medium according to claim 10, wherein in step 3, the LR of the pre-training part in retraining is 0.0001 to 0.0005; and the LR of the RNN structure and the classification layer in retraining is 0.001 to 0.007.

20. The non-transitory readable storage medium according to claim 10, wherein a size of a hidden layer of the bidirectional LSTM layer is 128.
